(19) United States
(12) Patent Application Publication
(10) Pub. No.: US 2008/0185210 A1
(43) Pub. Date: Aug. 7, 2008

(54) Motor Vehicle

(75) Inventor: Uwe Seidler, Boblingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/027,547

(22) Filed: Feb. 7, 2008

(30) Foreign Application Priority Data
Feb. 7, 2007 (DE) 10 2007 006 029.9

(51) Int. Cl. B60K 11/00

(52) U.S. Cl. 180/339

(57) ABSTRACT

A motor vehicle has a heat-radiating first component, in particular an exhaust system, and a temperature-sensitive second component disposed adjacently to the heat-radiating first component. At least one heat protection element is disposed between the two components and defines or separates a hot space lying between the first component and the heat protection element from a cold space lying between the second component and the heat protection element. A ventilation device is provided, which, at least when the motor vehicle is being driven, conducts cooling air for cooling the temperature-sensitive second component into the cold space and consequently ensures a constant air exchange in the cold space.

### CROSS-REFERENCE TO RELATED APPLICATION

This application claims the priority, under 35 U.S.C. § 119, of German application DE 10 2007 006 029.9, filed Feb. 7, 2007; the prior application is herewith incorporated by reference in its entirety.

### BACKGROUND OF THE INVENTION

### Field of the Invention

The present invention relates to a motor vehicle having a heat-radiating first component and a temperature-sensitive second component disposed adjacently to the heat-radiating first component. At least one heat protection element is disposed between the first and second components and defines a hot space lying between the first component and the heat protection element from a cold space lying between the second component and the heat protection element.

A middle tunnel of a motor vehicle, with a heat protection plate and with an exhaust system part guided in it, is known from German patent DE 198 36 970 C2. In this case, the heat protection plate is spaced apart from a tunnel wall and is configured as a downwardly open longitudinal duct. The exhaust system parts are in this case received in the longitudinal duct with a slight contact-preventing spacing with respect to the adjacent heat protection plate wall, so that the heat protection plate at the same time forms an air conduction device. A hot space is in this case formed between the exhaust system parts and the heat protection plate, while a cold space is formed between the tunnel wall and the heat protection plate. However, depending on the operating period and depending on the generation of heat in the exhaust system parts, the heat protection plate heats up, with the result that heat is transmitted from the hot space into the cold space. Depending on the generation of heat from the heat protection plate, the air in the cold space may in this case also warm up sharply in such a way that a temperature-sensitive component located in the cold space is not sufficiently protected against temperature.

A further heat protection element for an exhaust system of a motor vehicle is known, for example, from German patent DE 28 19 371 C2.

### BRIEF SUMMARY OF THE INVENTION

It is accordingly an object of the invention to provide a motor vehicle that overcomes the above-mentioned disadvantages of the prior art devices of this general type, which has an improved embodiment in which temperature-sensitive components can be protected particularly effectively against thermal load from an adjacently disposed heat-radiating component.

With the foregoing and other objects in view there is provided, in accordance with the invention, a motor vehicle. The motor vehicle contains a heat-radiating first component, a temperature-sensitive second component disposed adjacently to the heat-radiating first component, and at least one heat protection element disposed between the first and second components and separates a hot space lying between the first component and the heat protection element from a cold space lying between the second component and the heat protection element. A ventilation device is provided. At least when the motor vehicle is being driven, the ventilation device conducts cooling air for cooling the temperature-sensitive second component into the cold space.

The present invention is based on the general idea of disposing between a heat-radiating first component and a temperature-sensitive second component disposed adjacently to it, at least one heat protection element which subdivides the space lying between the two components into a hot space facing the heat-radiating component and a cold space facing away from the hot space and facing the temperature-sensitive component. A ventilation device is additionally provided which supplies the cold space with cooling air and thereby assists the cooling of the temperature-sensitive component. In contrast to a cold space having a purely insulating action, which may likewise heat up in the course of time, depending on the power of the heat-radiating component, and thereby leads to the transmission of heat to the temperature-sensitive component, this is ruled out virtually completely by the ventilation device according to the invention, since cooling air is supplied to the cold space preferably continuously and the transmission of heat from the hot space into the cold space and consequently to the temperature-sensitive component can thereby be reduced considerably. The ventilation device is preferably a passive ventilation device which supplies cooling air, for example in the form of a relative wind, to the cold space. However, depending on the thermal power of the heat-radiating component, an active ventilation device which supplies cooling air to the cold space, for example, by a blower may also be envisaged. The latter would have the great advantage that the cold space is supplied with cooling air even when a motor vehicle is at a standstill. Owing to the solution according to the invention, therefore, a particularly effective heat protection for the temperature-sensitive component can be achieved, which at the same time can be implemented in a structurally simple way and therefore cost-effectively.

The ventilation device expediently has a gap-like air inlet (NACA inlet) and a closed duct, adjoining the latter, for air routing. This affords the advantage that the air inlet can be placed at a structurally beneficial location and the cooling air can be delivered directly to the cold space and/or directly to the temperature-sensitive component by the duct adjoining the air inlet. NACA inlets, as they are known, were originally developed for aircraft technology and offer a large air inlet quantity, along with a low aerodynamic resistance, with the result that, on the one hand, the air resistance of the motor vehicle according to the invention remains virtually unchanged and, on the other hand, a sufficient supply of cooling air to the cold space can be ensured.

In a further advantageous embodiment of the solution according to the invention, the air inlet is disposed in an underbody trim of the motor vehicle. In this case, it is conceivable that the air inlet is formed in one piece with the underbody trim and can be produced, together with the latter, in one work step. Moreover, the air inlet may be disposed at a structurally particularly beneficial location of the underbody trim, with the result that a particularly effective cooling of the cold space can be ensured.

In a further advantageous embodiment of the solution according to the invention, a further heat protection element is disposed adjacently to the temperature-sensitive second component and separates the second component from the cold space. In the case of highly temperature-sensitive second components, the further heat protection element affords additional shielding with respect to a heat load, while it is conceivable that the ventilation device in this case supplies cooling air solely to the cold space lying between the two heat protection elements and/or to the space lying between the second heat protection element and the temperature-sensitive component. The latter, in particular, improves the shielding of the temperature-sensitive second component with respect to the heat-radiating first component considerably yet again.

It will be appreciated that the features mentioned above and those yet to be explained below may be used not only in the combination specified in each case, but also in other combinations or alone, without departing from the scope of the present invention.

Other features which are considered as characteristic for the invention are set forth in the appended claims.

Although the invention is illustrated and described herein as embodied in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a heat protection element according to the invention;

FIG. 2 is a sectional view taken along the section line II-II shown in FIG. 1; and

FIG. 3 is a sectional view taken along the sectional line III-III shown in FIG. 1.

### DETAILED DESCRIPTION OF THE INVENTION

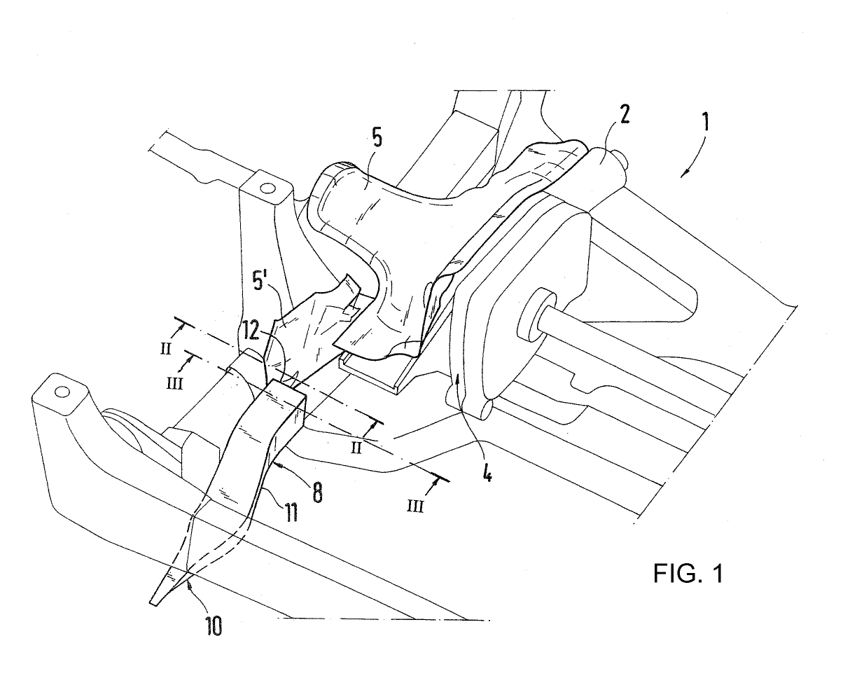

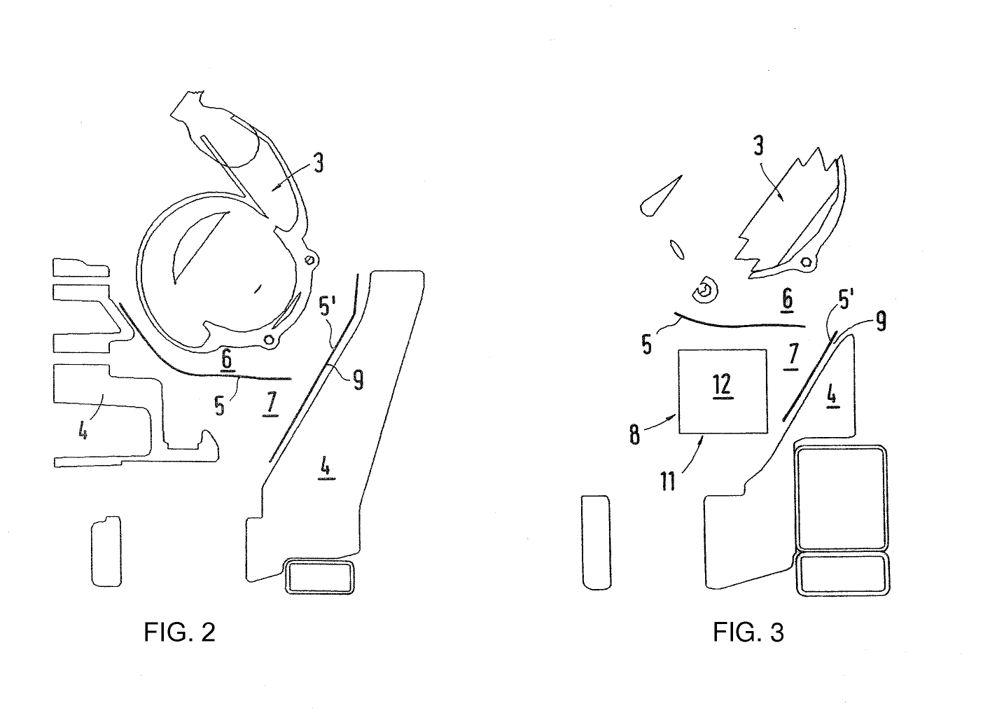

Referring now to the figures of the drawing in detail and first, particularly, to FIG. 1 thereof, there is shown a fore body chassis structure 1 of a motor vehicle, otherwise not illustrated, and a transmission 2, in particular a front axle transmission, being provided for driving a front axle, likewise not shown, of the motor vehicle. In close proximity to the transmission 2 is disposed a heat-radiating first component 3, in particular an exhaust system (see FIGS. 2 and 3), which, when the motor vehicle is in operation, warms up sharply on account of the hot engine exhaust gases. According to FIGS. 2 and 3, a second temperature-sensitive component 4 is disposed at a relatively slight spacing with respect to the first heat-radiating component 3, and in this case even a plurality of temperature-sensitive components may be disposed adjacently to the heat-radiating component 3. An excessive heating of the second component 4 must in this case be avoided without fail, since such heating may have an adverse effect on the second component 4. For this reason, between the two components 3 and 4, at least one heat protection element 5 is disposed, which separates a hot space 6 lying between the first component 3 and the heat protection element 5 from a cold space 7 lying between the second component 4 and the heat protection element 5. Direct heat radiation from the first component 3 to the temperature-sensitive second component 4 is thereby effectively prevented.

The air present in the cold space 7 in this case acts as an insulator which at least brakes a rapid transmission of heat from the hot space 6 via the cold space 7 to the second component 4. So that the transmission of heat between the first component 3 and the second component 4 can be reduced to an even greater extent, according to the invention a ventilation device 8 (see FIG. 1) is in this case provided, which when the motor vehicle is being driven, conducts cooling air for cooling the temperature-sensitive second component 4 in to the cold space 7. The ventilation device 8 is in this case preferably configured as a passive ventilation device, so that a supply of cooling air into the cold space 7 takes place generally only when the motor vehicle is being driven. In general, however, an active ventilation device may also be envisaged, for example a blower which blows cooling air into the cold space 7 even when the motor vehicle is at a standstill.

As a result of the constant exchange of air in the cold space 7, the air cannot heat up or can heat up to only a limited extent, with the result that a transmission of heat from the hot space 6 to the second component 4 is prevented preferably completely. As may be gathered further from FIGS. 2 and 3, a further heat protection element 5′ may be disposed in direct proximity to the temperature-sensitive second component 4 and separates the second component 4 from the cold space 7. It is conceivable, in this case, that the ventilation device 8 supplies cooling air to the cold space 7 and/or to a space 9 located between the further heat protection element 5′ and the second component 4. Furthermore, at least one of the two heat protection elements 5, 5′ may be configured as an air conduction element and divert or deflect an air stream conveyed by the ventilation device 8 into the cold space 7 and/or into the space 9.

According to FIG. 1, the heat protections 5, 5′ are configured as three-dimensional moldings which, according to a special embodiment, are produced from metal, in particular from sheet metal.

The ventilation device 8 has a gap-like air inlet 10 (NACA inlet) and a closed duct 11, adjoining the latter, for air routing. The duct 11 may have, for example, an angular or a round cross-sectional configuration and, moreover, may be adapted to structural boundary conditions in the underbody region of the motor vehicle. According to FIG. 1, the duct 11 has a generally s-shaped profile. The duct 11 may, for example, issue directly in the cold space 7 or upstream of the latter, an outlet port 12 preferably being formed such that it delivers cooling air to the cold space 7 or directly to the temperature-sensitive component 4. At its end facing away from the outlet port 12, the air inlet 10 is disposed, which, for example, may also be integrated into an underbody trim of the motor vehicle.

When the motor 1 is being driven, cooling air passes according to FIG. 1 via the air inlet 10 of the ventilation device 8 into the duct 11 and is routed in the latter as far as the outlet port 12. After leaving the duct 11, the cooling air enters the cold space 7 and ensures continuous air exchange there, so that the transmission of heat from the hot space 6 via the cold space 7 to the temperature sensitive component 4 can be prevented preferably completely. The heat protection element or heat protection elements 5, 5′ may in this case be fastened, for example, by screws, not designated in any more detail, as a result of which, in the event of maintenance, an easy exchange or an easy removal of the heat protection element 5, 5′ and therefore easier access to the transmission 2 can be ensured.

1. A motor vehicle, comprising:
a heat-radiating first component;
a temperature-sensitive second component disposed adjacently to said heat-radiating first component;
at least one heat protection element disposed between said first and second components and separating a hot space lying between said first component and said heat protection element from a cold space lying between said second component and said heat protection element; and
a ventilation device, at least when the motor vehicle is being driven, said ventilation device conducting cooling air for cooling said temperature-sensitive second component into said cold space.

2. The motor vehicle according to claim 1, further comprising a further heat protection element disposed adjacently to said temperature-sensitive second component and separates said second component from said cold space.

3. The motor vehicle according to claim 2, wherein at least one of said heat protection element and said further heat protection element is configured as an air conduction element and guides an air stream conveyed by said ventilation device into said cold space.

4. The motor vehicle according to claim 2, wherein at least one of said heat protection element and said further heat protection element is formed from metal.

5. The motor vehicle according to claim 1, wherein said ventilation device has a gap-shaped air inlet and a closed duct, adjoining said gap-shaped air inlet, for air routing.

6. The motor vehicle according to claim 5,
further comprising an underbody trim part; and
wherein said gap-shaped air inlet is disposed in said underbody trim part of the motor vehicle.

7. The motor vehicle according to claim 5, wherein said closed duct issues into said cold space.

8. The motor vehicle according to claim 5, further comprising a further air conduction element disposed downstream of said closed duct and is configured to deliver cooling air to said cold space.

9. The motor vehicle according to claim 1, wherein said temperature-sensitive second component is a transmission.

10. The motor vehicle according to claim 1, wherein said heat-radiating first component is an exhaust system.

11. The motor vehicle according to claim 2, wherein at least one of said heat protection element and said further heat protection element is formed from sheet metal.

12. The motor vehicle according to claim 5, wherein said closed duct has an outlet port disposed upstream of said cold space and is configured for delivering the cooling air to said cold space.

13. The motor vehicle according to claim 1, wherein said temperature-sensitive second component is a front axle transmission.
